(19) United States
(12) Patent Application Publication
(10) Pub. No.: US 2018/0270102 A1
(43) Pub. Date: Sep. 20, 2018

(54) DATA CENTER NETWORK FAULT DETECTION AND LOCALIZATION

(71) Applicant: Futurewei Technologies, Inc., Plano, TX (US)

(72) Inventors: Serhat Nazim Avci, Santa Clara, CA (US); Zhenjiang Li, Santa Clara, CA (US); Fangping Liu, San Jose, CA (US)

(21) Appl. No.: 15/459,879

(22) Filed: Mar. 15, 2017

(51) Int. Cl. H04L 12/24; H04L 29/08; H04L 12/26

(52) U.S. Cl. CPC H04L 41/06; H04L 43/0823; H04L 67/10

(57) ABSTRACT

One or more processors of a device execute instructions to identify a set of servers that includes a first server and a second server in a plurality of data centers; send a first list of servers to the first server; send a second list of servers to the second server; receive a first set of response data from the first server, the first set of response data indicating responsiveness of the servers in the first list of servers; receive a second set of response data from the second server, the second set of response data indicating responsiveness of the servers in the second list of servers; analyze the first set of response data and the second set of response data; and based on the analysis, generate an alert that indicates a network error in a data center.

### TECHNICAL FIELD

The present disclosure is related to fault detection in networks and, in particular, to automated fault detection, diagnosis, and localization in data center networks.

### BACKGROUND

Automated systems can measure network latency between pairs of servers in data center networks. System administrators review the measured network latencies to identify and diagnose faults.

### SUMMARY

A device comprises a memory storage comprising instructions, a network interface connected to a network, and one or more processors in communication with the memory storage. The one or more processors execute the instructions to perform: identifying a set of servers in a plurality of data centers, the set of servers including a first server and a second server; sending, via the network interface, a first list of servers in the set of servers to the first server; sending, via the network interface, a second list of servers in the set of servers to the second server; receiving, via the network interface, a first set of response data from the first server, the first set of response data indicating responsiveness of the servers in the first list of servers; receiving, via the network interface, a second set of response data from the second server, the second set of response data indicating responsiveness of the servers in the second list of servers; analyzing the first set of response data and the second set of response data; and based on the analysis, generating an alert that indicates a network error in a data center of the plurality of data centers.

A computer-implemented method for automated fault detection in data center networks comprises: identifying, by one or more processors, a set of servers in a plurality of data centers, the set of servers including a first server and a second server; sending, via a network interface, a first list of servers in the set of servers to the first server; sending, via the network interface, a second list of servers in the set of servers to the second server; receiving, via the network interface, a first set of response data from the first server, the first set of response data indicating responsiveness of the servers in the first list of servers; receiving, via the network interface, a second set of response data from the second server, the second set of response data indicating responsiveness of the servers in the second list of servers; analyzing, by the one or more processors, the first set of response data and the second set of response data; and based on the analysis, generating an alert that indicates a network error in a data center of the plurality of data centers.

A device comprises a memory storage comprising instructions, a network interface connected to a network, and one or more processors in communication with the memory storage. The one or more processors execute the instructions to perform: identifying a set of servers in a plurality of data centers, the set of servers including a first server and a second server; sending, via the network interface, a first list of servers in the set of servers to the first server; sending, via the network interface, a second list of servers in the set of servers to the second server; receiving, via the network interface, a first set of response data from the first server, the first set of response data indicating responsiveness of the servers in the first list of servers; receiving, via the network interface, a second set of response data from the second server, the second set of response data indicating responsiveness of the servers in the second list of servers; analyzing the first set of response data and the second set of response data; and based on the analysis, generating an alert that indicates a network error in a data center of the plurality of data centers.

A non-transitory computer-readable medium stores computer instructions for automated fault detection in data center networks, that when executed by one or more processors, cause the one or more processors to perform steps of: identifying a set of servers in a plurality of data centers, the set of servers including a first server and a second server; sending, via a network interface, a first list of servers in the set of servers to the first server; sending, via the network interface, a second list of servers in the set of servers to the second server; receiving, via the network interface, a first set of response data from the first server, the first set of response data indicating responsiveness of the servers in the first list of servers; receiving, via the network interface, a second set of response data from the second server, the second set of response data indicating responsiveness of the servers in the second list of servers; analyzing the first set of response data and the second set of response data; and based on the analysis, generating an alert that indicates a network error in a data center of the plurality of data centers.

Various examples are now described to introduce a selection of concepts in a simplified form that are further described below in the detailed description. The Summary is not intended to identify key or essential features of the claimed subject matter, nor is it intended to be used to limit the scope of the claimed subject matter.

According to one aspect of the present disclosure, a device comprises a memory storage comprising instructions, a network interface connected to a network, and one or more processors in communication with the memory storage. The one or more processors execute the instructions to perform: identifying a set of servers in a plurality of data centers, the set of servers including a first server and a second server; sending, via the network interface, a first list of servers in the set of servers to the first server; sending, via the network interface, a second list of servers in the set of servers to the second server; receiving, via the network interface, a first set of response data from the first server, the first set of response data indicating responsiveness of the servers in the first list of servers; receiving, via the network interface, a second set of response data from the second server, the second set of response data indicating responsiveness of the servers in the second list of servers; analyzing the first set of response data and the second set of response data; and based on the analysis, generating an alert that indicates a network error in a data center of the plurality of data centers.

Optionally, in any of the preceding aspects, a further implementation of the aspect provides that the analyzing of the first set of response data and the second set of response data comprises: determining a drop rate for a third server in the first list of servers.

Optionally, in any of the preceding aspects, a further implementation of the aspect provides that the analyzing of the first set of response data and the second set of response data comprises: determining a failure state for a third server in the first list of servers.

Optionally, in any of the preceding aspects, a further implementation of the aspect provides that the analyzing of the first set of response data and the second set of response data comprises: using a tree data structure in which each leaf node of the tree corresponds to a server of the set of servers; and determining that all servers in the set of servers corresponding to sibling nodes of a node corresponding to a third server in the set of servers report dropped packets to the third server.

Optionally, in any of the preceding aspects, a further implementation of the aspect provides that the analyzing of the first set of response data and the second set of response data comprises: using a tree data structure in which each leaf node of the tree corresponds to a server of the set of servers and each other node of the tree corresponds to a distinct subset of the set of servers; and determining that a node in the tree data structure and all children of the node are in a failure state.

Optionally, in any of the preceding aspects, a further implementation of the aspect provides that the analyzing of the first set of response data and the second set of response data comprises: using a tree data structure in which each leaf node of the tree corresponds to a server of the set of servers and each other node of the tree corresponds to a distinct subset of the set of servers; and determining that a node in the tree is in a failure state and that no children of the node are in the failure state.

Optionally, in any of the preceding aspects, a further implementation of the aspect provides that the analyzing of the first set of response data and the second set of response data comprises: determining that a third server in the set of servers is not in a failure state and that at least one child of the third server is in the failure state.

Optionally, in any of the preceding aspects, a further implementation of the aspect provides that the one or more processors further perform: creating the first list of servers by including each server in a same rack as the first server.

Optionally, in any of the preceding aspects, a further implementation of the aspect provides that the one or more processors further perform: creating the first list of servers by including a fourth server, based on the fourth server being in a different rack than the first server.

Optionally, in any of the preceding aspects, a further implementation of the aspect provides that the one or more processors further perform: creating the first list of servers by including a fifth server, based on the fifth server being in a different data center than the first server.

According to one aspect of the present disclosure, there is provided a computer-implemented method for automated fault detection in data center networks that comprises: identifying, by one or more processors, a set of servers in a plurality of data centers, the set of servers including a first server and a second server; sending, via a network interface, a first list of servers in the set of servers to the first server; sending, via the network interface, a second list of servers in the set of servers to the second server; receiving, via the network interface, a first set of response data from the first server, the first set of response data indicating responsiveness of the servers in the first list of servers; receiving, via the network interface, a second set of response data from the second server, the second set of response data indicating responsiveness of the servers in the second list of servers; analyzing, by the one or more processors, the first set of response data and the second set of response data; and based on the analysis, generating an alert that indicates a network error in a data center of the plurality of data centers.

Optionally, in any of the preceding aspects, a further implementation of the aspect provides that the analyzing of the first set of response data and the second set of response data comprises: determining a drop rate for a third server in the first list of servers.

Optionally, in any of the preceding aspects, a further implementation of the aspect provides that the analyzing of the first set of response data and the second set of response data comprises: determining a failure state for a third server in the first list of servers.

Optionally, in any of the preceding aspects, a further implementation of the aspect provides that the analyzing of the first set of response data and the second set of response data comprises: using a tree data structure in which each leaf node of the tree corresponds to a server of the set of servers; and determining that all servers in the set of servers corresponding to sibling nodes of a node corresponding to a third server in the set of servers report dropped packets to the third server.

Optionally, in any of the preceding aspects, a further implementation of the aspect provides that the analyzing of the first set of response data and the second set of response data comprises: using a tree data structure in which each leaf node of the tree corresponds to a server of the set of servers and each other node of the tree corresponds to a distinct subset of the set of servers; and determining that a node in the tree data structure and all children of the node are in a failure state.

Optionally, in any of the preceding aspects, a further implementation of the aspect provides that the analyzing of the first set of response data and the second set of response data comprises: using a tree data structure in which each leaf node of the tree corresponds to a server of the set of servers and each other node of the tree corresponds to a distinct subset of the set of servers; and determining that a node in the tree is in a failure state and that no children of the node are in the failure state.

Optionally, in any of the preceding aspects, a further implementation of the aspect provides that the analyzing of the first set of response data and the second set of response data comprises: using a tree data structure in which each leaf node of the tree corresponds to a server of the set of servers and each other node of the tree corresponds to a distinct subset of the set of servers; and determining that a node is not in a failure state and that at least one child of the node is in the failure state.

According to one aspect of the present disclosure, there is provided a non-transitory computer-readable medium that stores computer instructions for automated fault detection in data center networks that, when executed by one or more processors, cause the one or more processors to perform steps of: identifying a set of servers in a plurality of data centers, the set of servers including a first server and a second server; sending, via a network interface, a first list of servers in the set of servers to the first server; sending, via the network interface, a second list of servers in the set of servers to the second server; receiving, via the network interface, a first set of response data from the first server, the first set of response data indicating responsiveness of the servers in the first list of servers; receiving, via the network interface, a second set of response data from the second server, the second set of response data indicating responsiveness of the servers in the second list of servers; analyzing the first set of response data and the second set of response data; and based on the analysis, generating an alert that indicates a network error in a data center of the plurality of data centers.

Optionally, in any of the preceding aspects, a further implementation of the aspect provides that the analyzing of the first set of response data and the second set of response data comprises: determining a drop rate for a third server in the first list of servers.

Optionally, in any of the preceding aspects, a further implementation of the aspect provides that the analyzing of the first set of response data and the second set of response data comprises: determining a failure state for a third server in the first list of servers.

Any one of the foregoing examples may be combined with any one or more of the other foregoing examples to create a new embodiment within the scope of the present disclosure.

### BRIEF DESCRIPTION OF THE DRAWINGS

FIG. 1 is a block diagram illustration of servers organized into racks in communication with a controller and a trace collector cluster suitable for automated fault detection, diagnosis, and localization in data center networks, according to some example embodiments.

FIG. 2 is a block diagram illustration of racks organized into data centers in communication with a controller and a trace collector cluster suitable for automated fault detection, diagnosis, and localization in data center networks, according to some example embodiments.

FIG. 3 is a block diagram illustration of data centers organized into availability zones in communication with a controller and a trace collector cluster suitable for automated fault detection, diagnosis, and localization in data center networks, according to some example embodiments.

FIG. 4 is a block diagram illustration of modules of a controller suitable for automated fault detection, diagnosis, and localization in data center networks, according to some example embodiments.

FIG. 5 is a block diagram illustration of modules of an analyzer cluster suitable for automated fault detection, diagnosis, and localization in data center networks, according to some example embodiments.

FIG. 6 is a block diagram illustration of a tree data structure suitable for use in automated fault detection, diagnosis, and localization in data center networks, according to some example embodiments

FIG. 7 is a block diagram illustration of a data format suitable for use in automated fault detection, diagnosis, and localization in data center networks, according to some example embodiments.

FIG. 8 is a flowchart illustration of a method of automated fault detection, diagnosis, and localization in data center networks, according to some example embodiments.

FIGS. 9-10 are a flowchart illustration of a method of automated fault detection, diagnosis, and localization in data center networks, according to some example embodiments.

FIG. 11 is a block diagram illustration of a data format suitable for use in automated fault detection, diagnosis, and localization in data center networks, according to some example embodiments.

FIG. 12 is a flowchart illustration of a method of probe list creation, according to some example embodiments.

FIG. 13 is a block diagram illustrating circuitry for clients and servers that implement algorithms and perform methods, according to some example embodiments.

### DETAILED DESCRIPTION

In the following description, reference is made to the accompanying drawings that form a part hereof, and in which are shown, by way of illustration, specific embodiments which may be practiced. These embodiments are described in sufficient detail to enable those skilled in the art to practice the inventive subject matter, and it is to be understood that other embodiments may be utilized and that structural, logical, and electrical changes may be made without departing from the scope of the present disclosure. The following description of example embodiments is, therefore, not to be taken in a limiting sense, and the scope of the present disclosure is defined by the appended claims.

The functions or algorithms described herein may be implemented in software, in one embodiment. The software may consist of computer-executable instructions stored on computer-readable media or a computer-readable storage device such as one or more non-transitory memories or other types of hardware-based storage devices, either local or networked. The software may be executed on a digital signal processor, application-specific integrated circuit (ASIC), programmable data plane chip, field-programmable gate array (FPGA), microprocessor, or other type of processor operating on a computer system, such as a switch, server, or other computer system, turning such a computer system into a specifically programmed machine.

Hierarchical proactive end-to-end probing of network communication in data center networks is used to determine when servers, racks, data centers, or availability zones become inoperable or unreachable. Agents running on servers in the data center network report trace results to a centralized trace collector cluster that stores the trace results in a database. An analyzer server cluster analyzes the trace results to identify faults in the data center network. Results of the analysis are presented using a visualization tool. Additionally or alternatively, alerts are sent to a system administrator based on the results of the analysis.

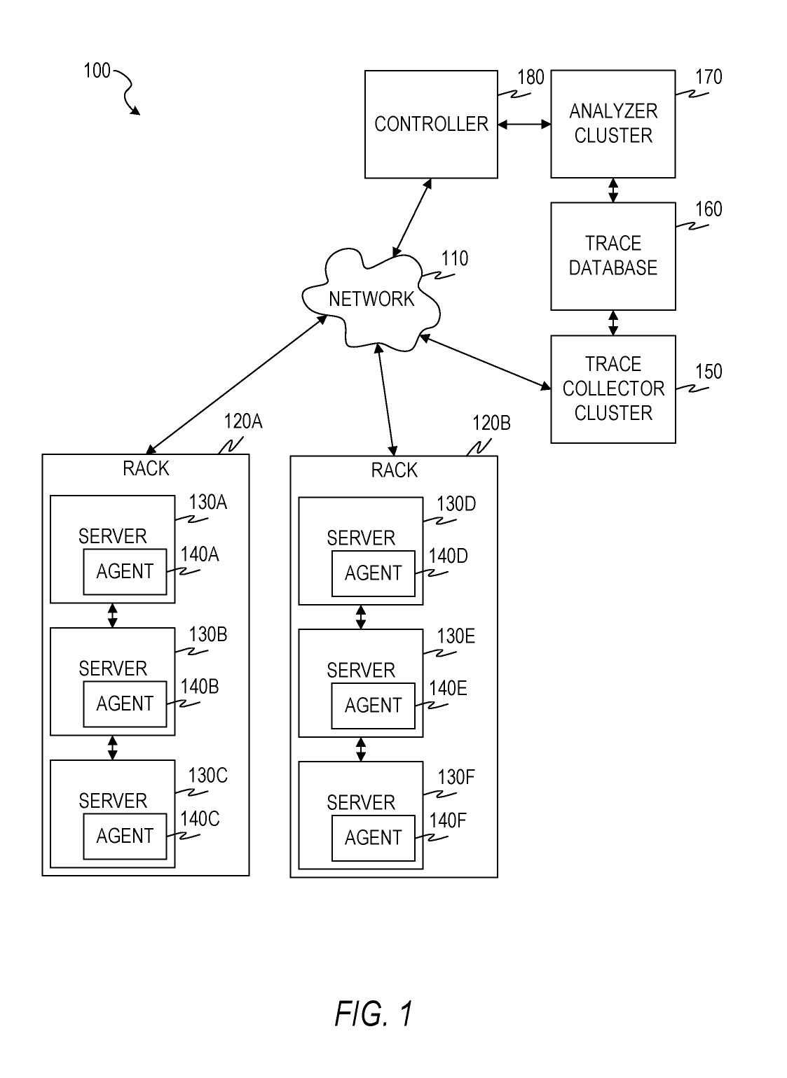

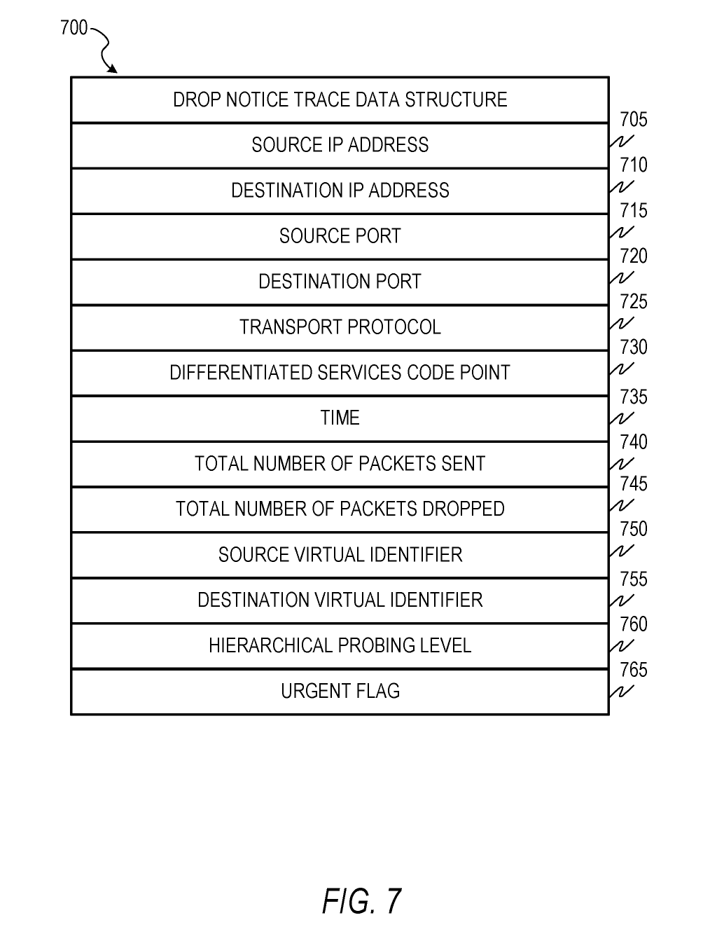

FIG. 1 is a block diagram illustration 100 of servers 130A, 130B, 130C, 130D, 130E, and 130F organized into racks 120A and 120B in communication with a controller 180 and a trace collector cluster 150 suitable for automated fault detection, diagnosis, and localization in data center networks, according to some example embodiments. A rack is a collection of servers that are physically connected to a single hardware frame. Each server 130A-130F runs a corresponding agent 140A, 140B, 140C, 140D, 140E, or 140F. For example, the servers 130A-130F may run application programs for use by end users and also run an agent 140A-140F as a software application. The agents 140A-140F communicate via the network 110 or another network with the controller 180 to determine which servers each agent should communicate with to generate trace data (described in more detail below with respect to FIG. 7). The agents 140A-140F communicate via the network 110 or another network with the trace collector cluster 150 to report the trace data.

A trace database 160 stores traces generated by the agents 140A-140F and received by the trace collector cluster 150. An analyzer cluster 170 accesses the trace database 160 and analyzes the stored traces to identify network and server failures. The analyzer cluster 170 may report identified failures through a visualization tool or by generating alerts to a system administrator (e.g., text-message alerts, email alerts, instant messaging alerts, or any suitable combination thereof). The controller 180 generates lists of routes to be traced by each of the servers 130A-130F. The lists may be generated based on reports generated by the analyzer cluster 170. For example, routes that would otherwise be assigned to a server determined to be in a failure state by the analyzer cluster 170 may instead be assigned to other servers by the controller 180.

The network 110 may be any network that enables communication between or among machines, databases, and devices. Accordingly, the network 110 may be a wired network, a wireless network (e.g., a mobile or cellular network), or any suitable combination thereof. The network 110 may include one or more portions that constitute a private network, a public network (e.g., the Internet), or any suitable combination thereof.

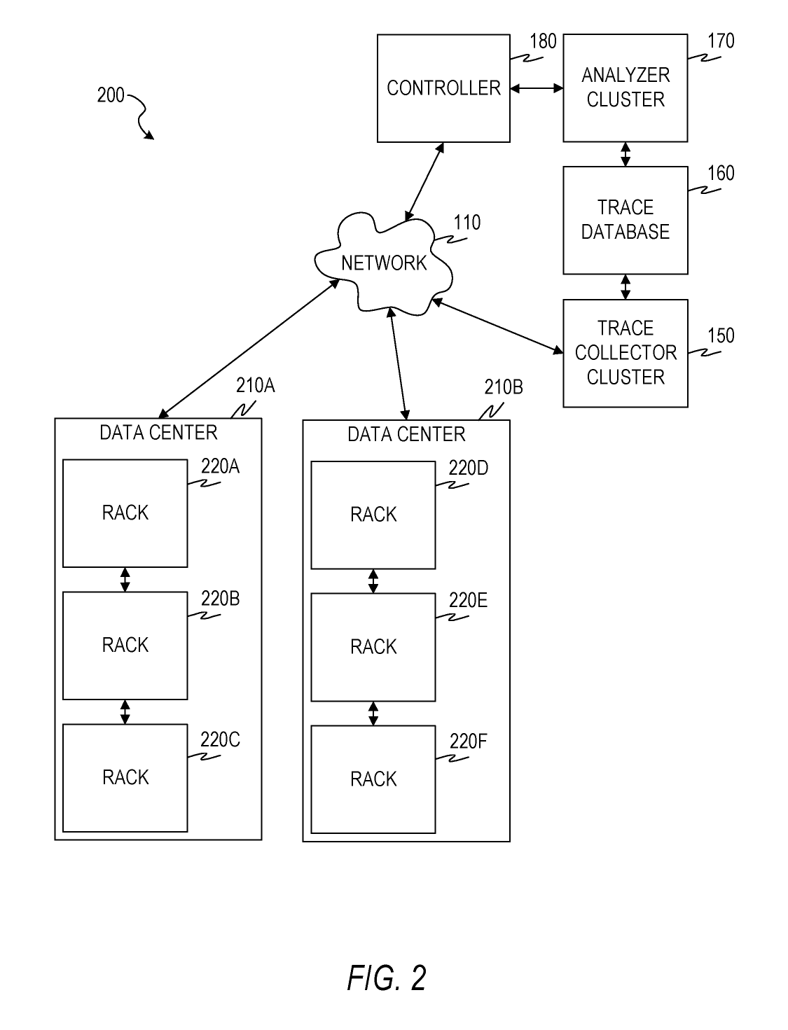

FIG. 2 is a block diagram illustration 200 of racks 220A, 220B, 220C, 220D, 220E, and 220F organized into data centers 210A and 210B in communication with the controller 180 and the trace collector cluster 150 suitable for automated fault detection, diagnosis, and localization in data center networks, according to some example embodiments. The network 110, trace collector cluster 150, trace database 160, analyzer cluster 170, and controller 180 are described above with respect to FIG. 1.

A data center is a collection of racks that are located at a physical location. Each server in each rack 220A-220F may run an agent that communicates with the controller 180 to determine which servers each agent should communicate with to generate trace data and with the trace collector cluster 150 to report the trace data. As a result, servers in different ones of the data centers 210A and 210B may determine their connectivity via the network 110, generate resulting traces, and send those traces to the trace collector cluster 150.

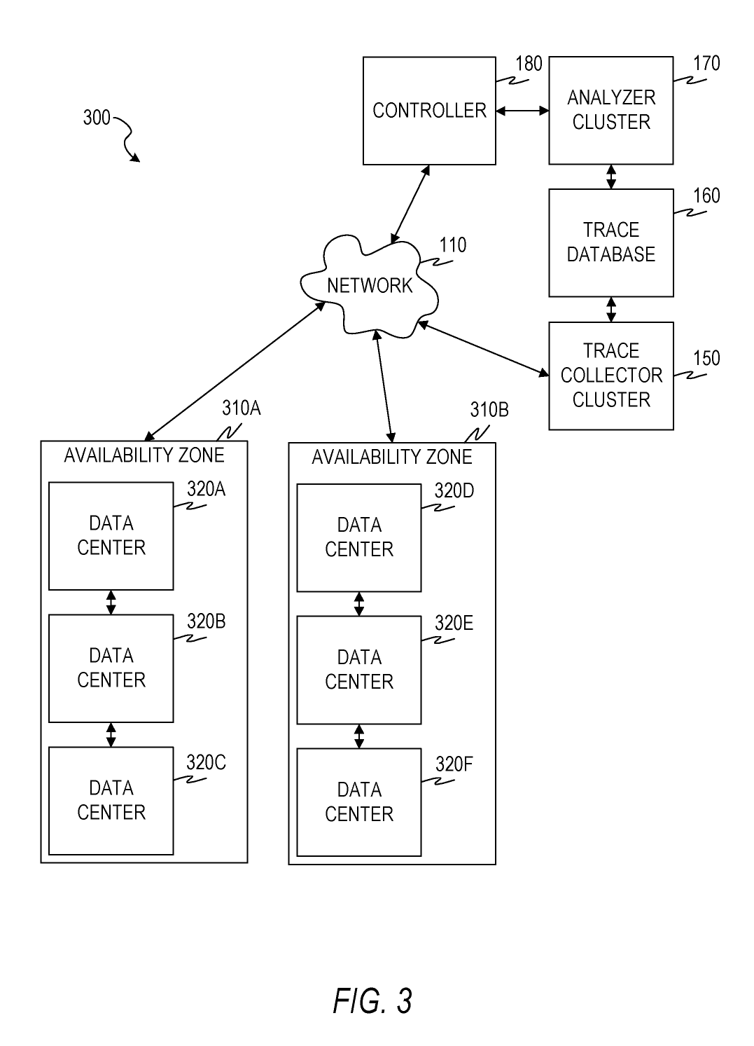

FIG. 3 is a block diagram illustration 300 of data centers 320A, 320B, 320C, 320D, 320E, and 320F organized into availability zones 310A and 310B in communication with the controller 180 and the trace collector cluster 150 suitable for automated fault detection, diagnosis, and localization in data center networks, according to some example embodiments. The network 110, trace collector cluster 150, trace database 160, analyzer cluster 170, and controller 180 are described above with respect to FIG. 1.

An availability zone is a collection of data centers. The organization of data centers into an availability zone may be based on geographical proximity, network latency, business organization, or any suitable combination thereof. Each server in each data center 320A-320F may run an agent that communicates with the controller 180 to determine which servers each agent should communicate with to generate trace data and with the trace collector cluster 150 to report the trace data. As a result, servers in different ones of the availability zones 310A and 310B may determine their connectivity via the network 110, generate resulting traces, and send those traces to the trace collector cluster 150.

As can be seen by considering FIGS. 1-3 together, any number of servers may be organized into each rack, subject to the physical constraints of the racks, any number of racks may be organized into each data center, subject to the physical constraints of the data centers, any number of data centers may be organized into each availability zone, and any number of availability zones may be supported by each trace collector cluster, trace database, analyzer cluster, and controller. In this way, large numbers of servers (even millions or more) can be organized in a hierarchical manner

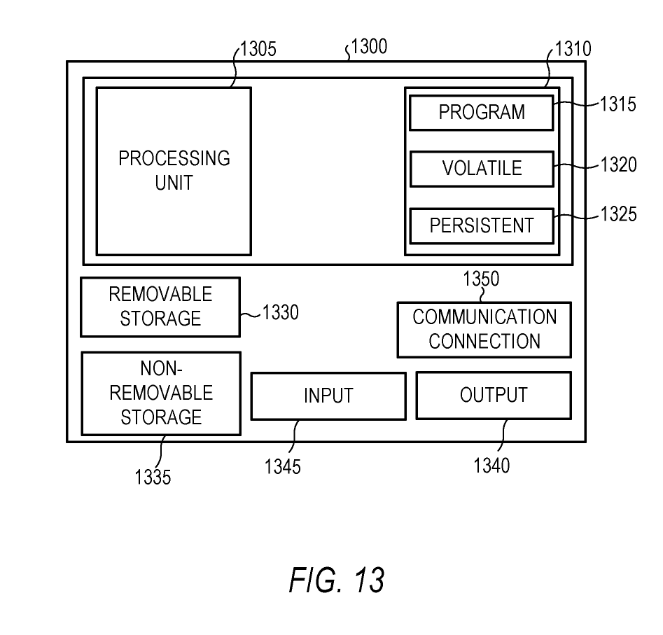

Any of the machines or devices shown in FIGS. 1-3 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 13. As used herein, a “database” is a data storage resource and may store data structured as a text file, a table, a spreadsheet, a relational database (e.g., an object-relational database), a triple store, a hierarchical data store, a document-oriented NoSQL database, a file store, or any suitable combination thereof. The database may be an in-memory database. Moreover, any two or more of the machines, databases, or devices illustrated in FIGS. 1-3 may be combined into a single machine, database, or device, and the functions described herein for any single machine, database, or device may be subdivided among multiple machines, databases, or devices.

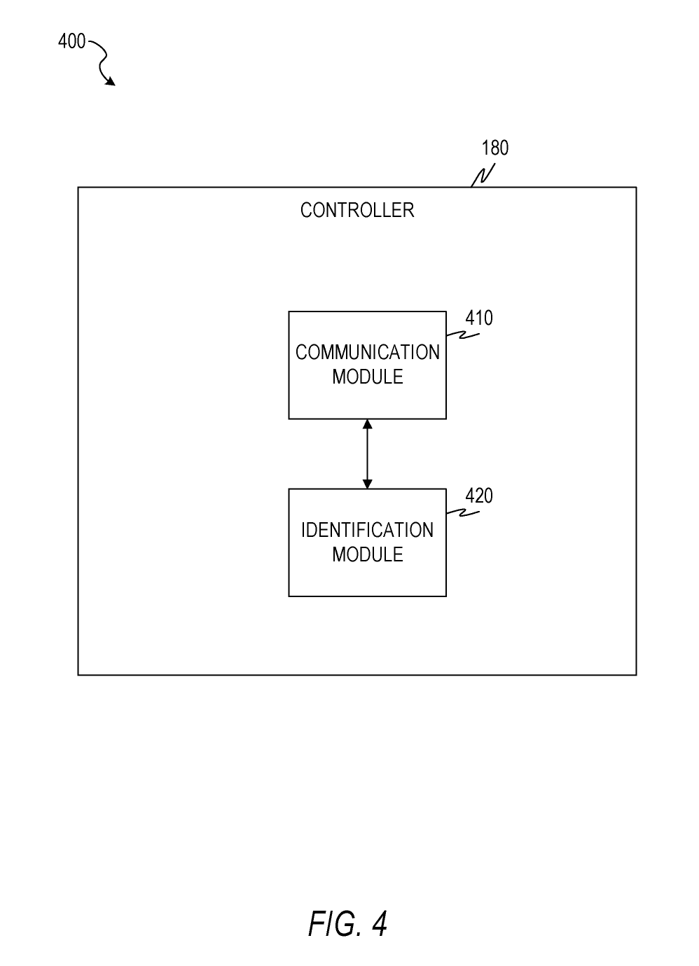

FIG. 4 is a block diagram illustration 400 of modules of a controller 180 suitable for automated fault detection, diagnosis, and localization in data center networks, according to some example embodiments. As shown in FIG. 4, the controller 180 comprises the communication module 410 and the identification module 420, configured to communicate with each other (e.g., via a bus, shared memory, or a switch). Any one or more of the modules described herein may be implemented using hardware (e.g., a processor of a machine, an application-specific integrated circuit (ASIC), field-programmable gate array (FPGA), or any suitable combination thereof). Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The communication module 410 is configured to send and receive data. For example, the communication module 410 may send instructions to the servers 130A-130F via the network 110 that indicate which other servers should be probed by each agent 140A-140F. As another example, the communication module 410 may receive data from the analyzer cluster 170 that indicates which servers 130A-130F, racks 220A-220F, data centers 320A-320F, or availability zones 310A-310B are in a failure state.

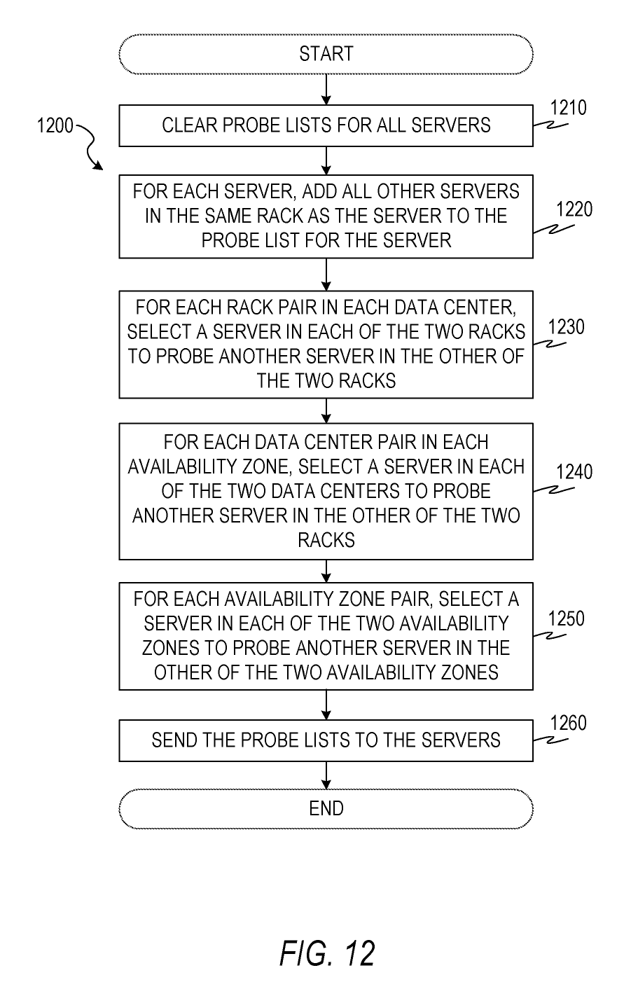

The identification module 420 is configured to identify a set of servers 130A-130F to be probed by each agent 140A-140F based on the network topology and analysis data received from the analyzer cluster 170. For example, an algorithm corresponding to the method 1200 of FIG. 12 may be used.

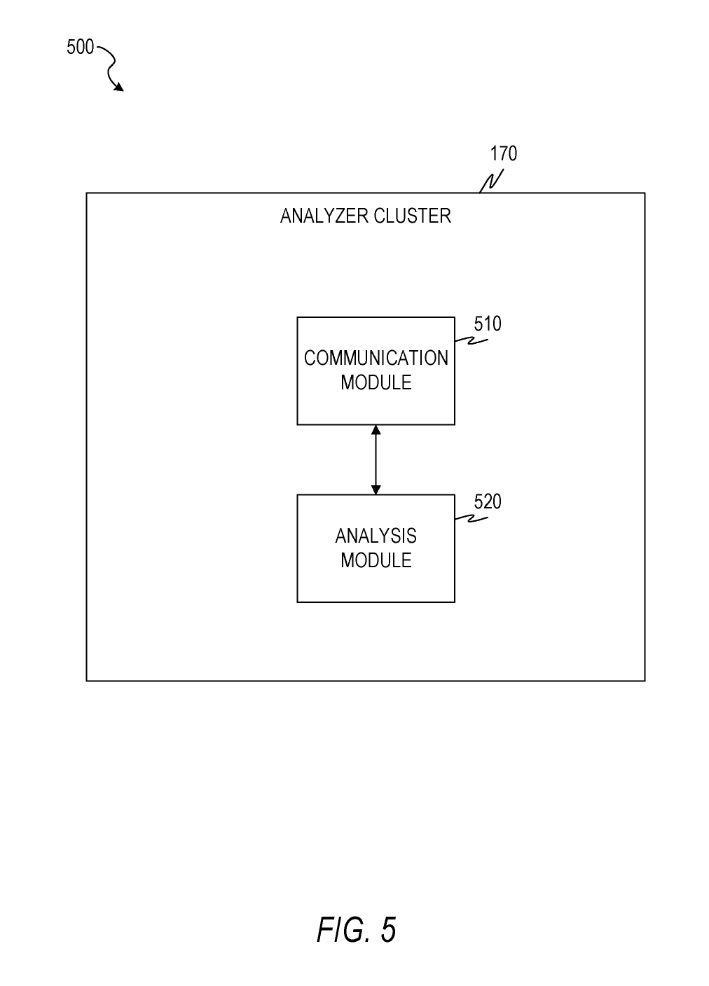

FIG. 5 is a block diagram illustration 500 of modules of an analyzer cluster 170 suitable for automated fault detection, diagnosis, and localization in data center networks, according to some example embodiments. As shown in FIG. 5, the analyzer cluster 170 comprises the communication module 510 and the analysis module 520, configured to communicate with each other (e.g., via a bus, shared memory, or a switch).

The communication module 510 is configured to send and receive data. For example, the communication module 510 may send data to the controller 180 via the network 110 or another network connection that indicates which servers 130A-130F, racks 220A-220F, data centers 320A-320F, or availability zones 310A-310B are in a failure state. As another example, the communication module 510 may access the trace database 160 to access the results of previous probe traces for analysis.

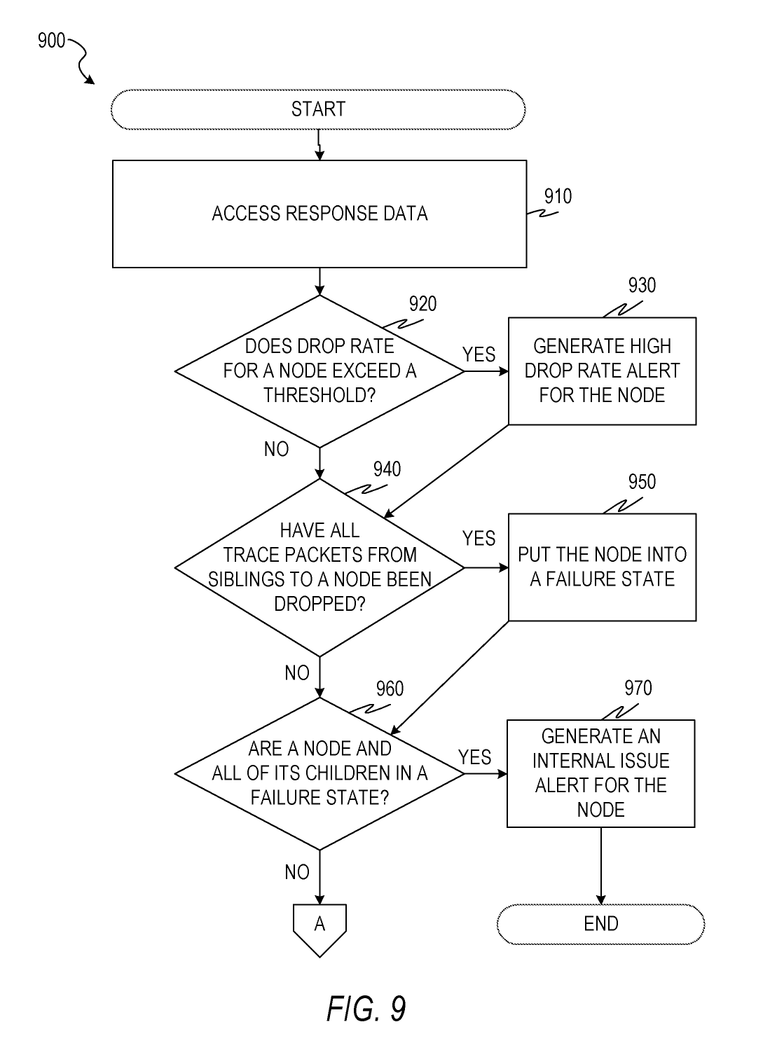

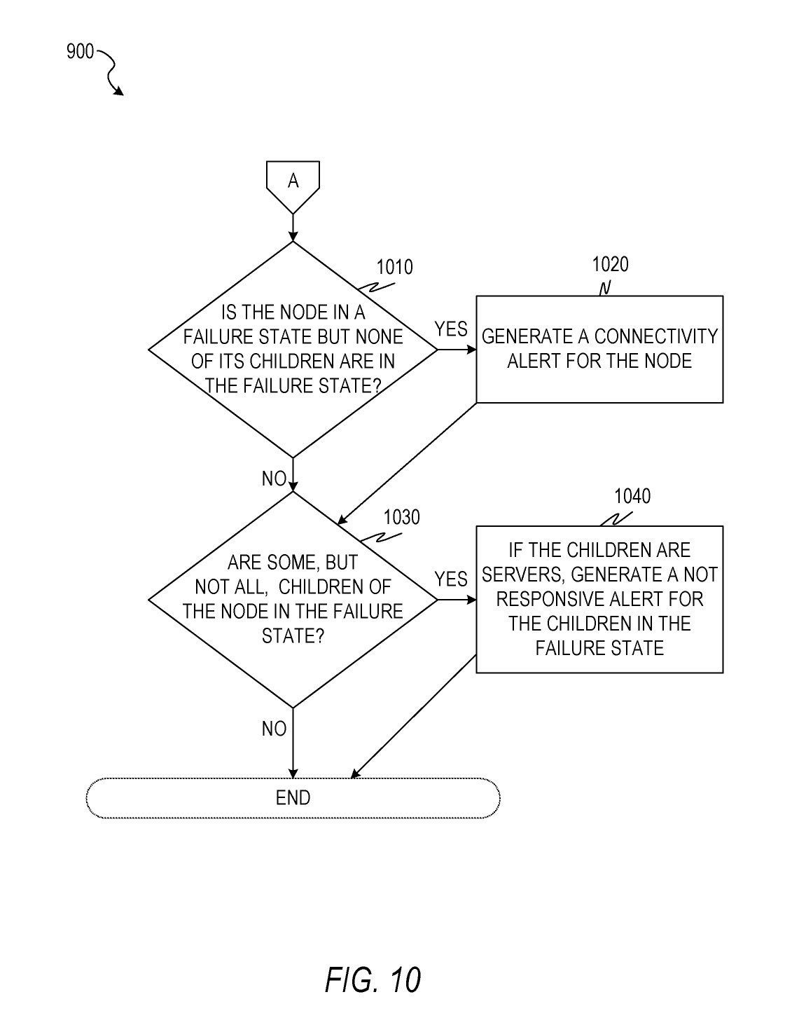

The analysis module 520 is configured to analyze trace data to identify network and server failures. For example, the algorithm discussed below with respect to FIGS. 9-10 may be used.

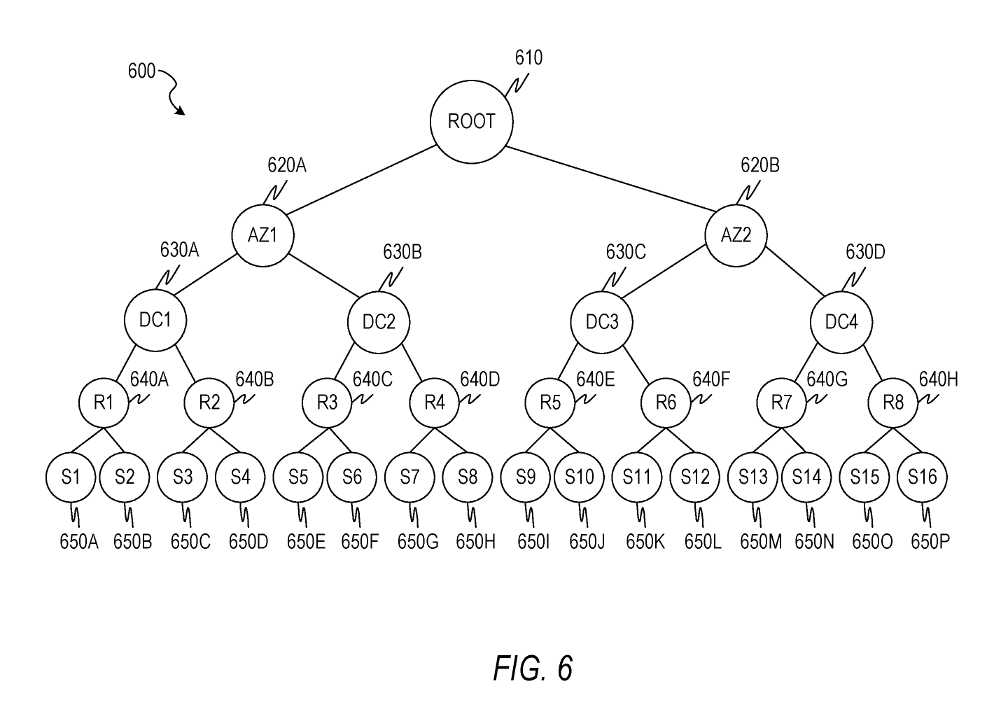

FIG. 6 is a block diagram illustration of a tree data structure 600 suitable for use in automated fault detection, diagnosis, and localization in data center networks, according to some example embodiments. The tree data structure 600 includes a root node 610, availability zone nodes 620A and 620B, data center nodes 630A, 630B, 630C, and 630D, rack nodes 640A, 640B, 640C, 640D, 640E, 640F, 640G, and 640H, and server nodes 650A, 650B, 650C, 650D, 650E, 650F, 650G, 650H, 650I, 650J, 650K, 650L, 650M, 650N, 6500, and 650P.

The tree data structure 600 may be used by the trace collector cluster 150, the analyzer cluster 170, and the controller 180 in identifying problems with servers and network connections, in generating alerts regarding problems with servers and network connections, or both. The server nodes 650A-650P represent servers in the network. The rack nodes 640A-640H represent racks of servers. The data center nodes 630A-630D represent data centers. The availability zone nodes 620A-620B represent availability zones. The root node 610 represents the entire network.

Thus, problems associated with an individual server are associated with one of the leaf nodes 650A-650P, problems associated with an entire rack are associated with one of the nodes 640A-640H, problems associated with a data center are associated with one of the nodes 630A-630D, problems associated with an availability zone are associated with one of the nodes 620A-620B, and problems associated with the entire network are associated with the root node 610. Similarly, the tree data structure 600 may be traversed by the analyzer cluster 170 in identifying problems. For example, instead of considering each server in the network in an arbitrary order, the tree data structure 600 may be used to evaluate servers based on their organization into racks, data centers, and availability zones.

FIG. 7 is a block diagram illustration of a data format of a drop notice trace data structure 700 suitable for use in automated fault detection, diagnosis, and localization in data center networks, according to some example embodiments. Shown in the drop notice trace data structure 700 are a source Internet protocol (IP) address 705, a destination IP address 710, a source port 715, a destination port 720, a transport protocol 725, a differentiated services code point 730, a time 735, a total number of packets sent 740, a total number of packets dropped 745, a source virtual identifier 750, a destination virtual identifier 755, a hierarchical probing level 760, and an urgent flag 765.

The drop notice trace data structure 700 may be transmitted from a server (e.g., one of the servers 130A-130F) to the trace collector cluster 150 to report on a trace from the server to another server. The source IP address 705 and destination IP address 710 indicate the IP addresses of the source and destination of the route, respectively. The source port 715 indicates the port used by the source server to send the route trace message to the destination server. The destination port 720 indicates the port used by the destination server to receive the route trace message.

The transport protocol 725 indicates the transport protocol (e.g., transmission control protocol (TCP) or user datagram protocol (UDP)). The differentiated services code point 730 identifies a particular code point for the identified protocol. The code point may be used by the destination server in determining how to process the trace. The time 735 indicates the date/time (e.g., seconds elapsed in epoch) at which the drop notice trace data structure 700 was generated. The total number of packets sent 740 indicates the total number of packets sent by the source server to the destination server. The total number of packets dropped 745 indicates the total number of responses not received by the source server from the destination server. The source virtual identifier 750 and destination virtual identifier 755 contain virtual identifiers for the source and destination servers. For example, the controller 180 may assign a virtual identifier to each server running agents under the control of the controller 180.

The hierarchical probing level 760 indicates the distance between the source server and the destination server. For example, two servers in the same rack may have a probing level of 1; two servers in different racks in the same data center may have a probing level of 2; two servers in different data centers in the same availability zone may have a probing level of 3; and two servers in different availability zones may have a probing level of 4. The urgent flag 765 is a Boolean value indicating whether or not the drop notice trace is urgent. The urgent flag 765 may be set to false by default and to true if the particular trace was indicated as urgent by the controller 180. The trace collector cluster 150 may prioritize the processing of drop notice trace data structure 700 based on the value of the urgent flag 765.

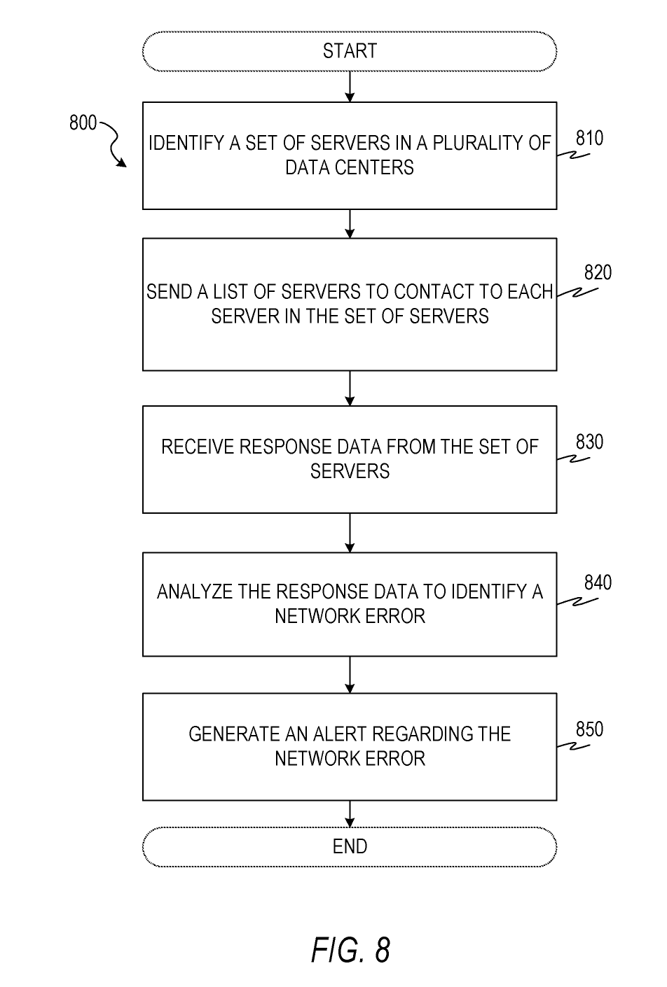

FIG. 8 is a flowchart illustration of a method 800 of automated fault detection, diagnosis, and localization in data center networks, according to some example embodiments. The method 800 includes operations 810, 820, 830, 840, and 850. By way of example and not limitation, the method 800 is described as being performed by the trace collector cluster 150, trace database 160, analyzer cluster 170, and controller 180 of FIGS. 1-3.

In operation 810, the controller 180 identifies a set of servers (e.g., the servers 130A-130F) in a plurality of data centers (e.g., the data centers 320A-320F). The set of servers includes a first server and a second server (e.g., the servers 130A and the server 130B). The controller 180 sends, via a network interface, a list of servers to contact to at least a subset of the set of servers (operation 820). For example, a first list of servers in the set of servers may be sent to the first server and a second list of servers in the set of servers may be sent to the second server. In some example embodiments, each server is sent a list that includes every other server in the same rack and one server in each other rack in the same data center. Additionally, inter-data-center and inter-availability-zone probing is supported. To verify a connection between two data centers, one or more servers in the first data center is assigned one or more servers in the second data center to contact. Similarly, to verify a connection between two availability zones, one or more servers in the first availability zone is assigned one or more servers in the second availability zone to contact. The method 1200, described with respect to FIG. 12 below, may be used to generate probe lists.

An example partial assignment list is below, in which the load of inter-data-center and inter-available-zone probing is divided as evenly as possible between servers and racks. In the example, there are three servers per rack, three racks per data center, three data centers per availability zone, and three availability zones, for a total of 81 servers. The servers are numbered S1-S81; the racks are numbered R1-R27; the data centers are numbered DC1-DC9; and the availability zones are numbered AZ1-AZ3. The servers in the lists are indicated as being in the same rack (R), in a different rack in the same data center (DC), in a different data center in the same availability zone (AZ), or in a different availability zone (Inter-AZ).

| Server | List |
|---|---|
| S1 (in R1, DC1, AZ1) | S2 (R), S3 (R), S4 (DC) |
| S2 (in R1, DC1, AZ1) | S1 (R), S3 (R), S7 (DC) |
| S3 (in R1, DC1, AZ1) | S1 (R), S2 (R), S10 (AZ) |
| S4 (in R2, DC1, AZ1) | S5 (R), S6 (R), S2 (DC) |
| S5 (in R2, DC1, AZ1) | S4 (R), S6 (R), S8 (DC) |
| S6 (in R2, DC1, AZ1) | S5 (R), S6 (R), S19 (AZ) |
| S7 (in R3, DC1, AZ1) | S8 (R), S9 (R), S3 (DC) |
| S8 (in R3, DC1, AZ1) | S7 (R), S9 (R), S6 (DC) |
| S9 (in R3, DC1, AZ1) | S7 (R), S8 (R), S28 (Inter-AZ) |
| . . . | |
| S16 (in R3, DC2, AZ1) | S17 (R), S18 (R), S12 (DC) |
| S17 (in R3, DC2, AZ1) | S16 (R), S18 (R), S15 (DC) |
| S18 (in R3, DC2, AZ1) | S17 (R), S18 (R), S55 (Inter-AZ) |
| . . . | |
| S25 (in R3, DC3, AZ1) | S26 (R), S27 (R), S21 (DC) |
| S26 (in R3, DC3, AZ1) | S25 (R), S27 (R), S24 (DC) |
| S27 (in R3, DC3, AZ1) | S25 (R), S26 (R) |

After receiving the lists of servers to contact, each server S1-S81 sends a probe packet to each server in the list. Based on responses received (or dropped), the servers S1-S81 send trace data to the trace collector cluster 150. In operation 830, the trace collector cluster 150 receives response data from some or all of the set of servers. For example, each server may send a drop notice trace data structure 700 to the trace collector cluster 150 for each destination server on its list of servers to contact. Failure to receive one or more drop notice trace data structures 700 from a server within a predetermined period of time may indicate a network connection failure between the trace collector cluster 150 and the server or a failure of the server itself. In some example embodiments, the trace collector cluster 150 receives, via the network interface, a first set of response data from the first server, the first set of response data indicating responsiveness of the servers in the first list of servers. The trace collector cluster 150 may further receive, via the network interface, a second set of response data from the second server, the second set of response data indicating responsiveness of the servers in the second list of servers.

For example, if the expected round-trip time is 0.5 seconds, then if no response is received within 1 second, the agent 140A may determine that no response is received. In some example embodiments, a number of probes are sent by each agent to its destination list. In some example embodiments, the number of iterations in which no response was received from each destination server (i.e. the number of dropped packets between the destination server and the source server for the iterations) is compared to a threshold to determine if there is a connection problem between the two servers. The threshold may apply to the entire set of iterations, or to consecutive iterations. For example, in one embodiment, when three packets are dropped out of ten, regardless of order, a drop trace is sent. In another embodiment, the drop trace would only be sent if three consecutive packets were dropped.

In some example embodiments, data received by the trace collector cluster 150 is stored in the trace database 160.

In operation 840, the analyzer cluster 170 analyzes the response data (e.g., response data stored in the trace database 160 including the first set of response data and the second set of response data) to identify one or more network errors. For example, if every server requested to probe a target server reports that all packets were dropped, but packets for other servers in the same rack as the target server were received, a determination may be made that the target server is in a failure state. As another example, if inter-data center packets destined for a particular data center are dropped, but intra-data center packets for the particular data center are successfully received, a determination may be made that the inter-data center network connection for the particular data center is inoperable.

The analyzer cluster 170 generates an alert regarding the network error (operation 850). For example, if a server failure is identified, an email or text message may be sent to an email account or phone number associated with a network administrator responsible for the server (e.g., an administrator associated with the data center of the server). As another example, an application or web interface may be used to monitor alerts. In some example embodiments, the generated alert indicates a network error in a data center of the plurality of data centers.

FIGS. 9-10 are a flowchart illustration of a method 900 of automated fault detection, diagnosis, and localization in data center networks, according to some example embodiments. The method 900 includes operations 910, 920, 930, 940, 950, 960, 970, 1010, 1020, 1030, and 1040. By way of example and not limitation, the method 900 is described as being performed by the trace collector cluster 150, trace database 160, analyzer cluster 170, and controller 180 of FIGS. 1-5, along with the tree data structure 600 of FIG. 6. The generated alerts may use the alert data structure 1000, discussed with respect to FIG. 10, below.

In operation 910, the analyzer cluster 170 accesses response data stored in the trace database 160. For example, response data received in operation 830 may be accessed.

In operation 920, the analyzer cluster 170 determines if the drop rate for a node exceeds a threshold. For example, the analyzer cluster 170 may create the tree data structure 600, in which one node corresponds to each server, rack, data center, and availability zone. The drop rate (e.g., total number of dropped packets, number of dropped packets within a period of time, total percentage of dropped packets, percentage of dropped packets within a period of time, or any suitable combination thereof) is compared to the threshold, which may depend on the type of node (e.g., the number or percentage of dropped packets used as a threshold may be different for nodes that correspond to individual servers than for nodes that correspond to data centers).

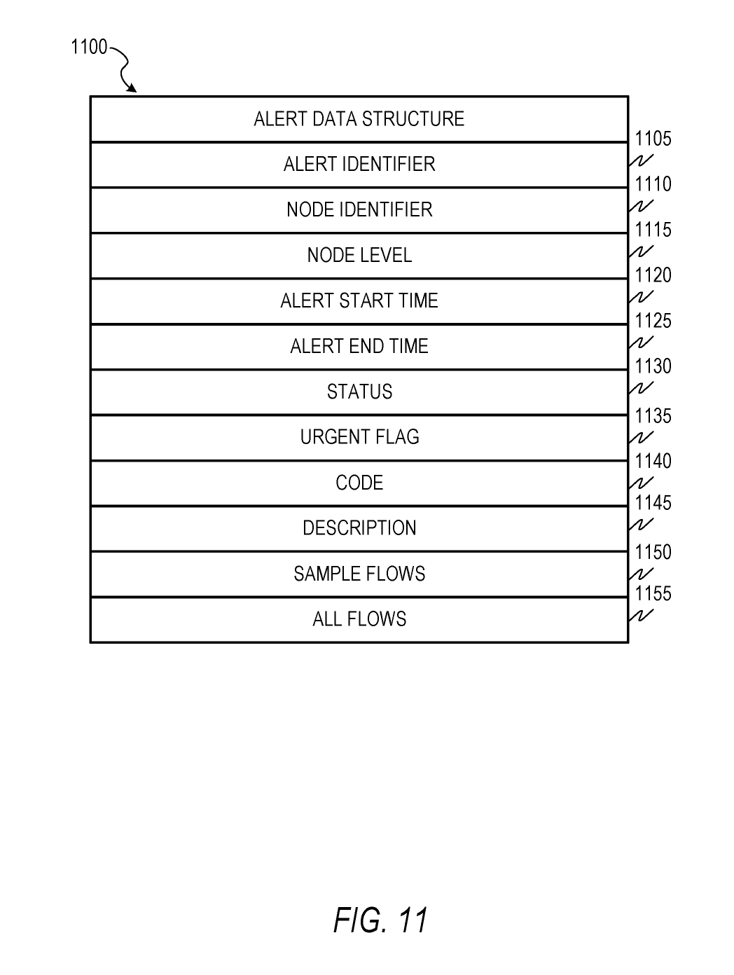

If the drop rate for the node exceeds the threshold, the analyzer cluster 170 generates a high drop rate alert for the node (operation 930). The generated high drop rate alert may use the alert data structure 1100, discussed with respect to FIG. 11, below. Whether or not the high drop rate alert is generated, the method 900 proceeds with operation 940.

In operation 940, the analyzer cluster 170 determines if all trace packets to a node from its siblings have been dropped. Sibling nodes are nodes having the same parent (e.g., the nodes 650A-650B representing servers in a rack (itself represented by the node 640A) are siblings, the nodes 640A-640B representing racks in a data center (itself represented by the node 630A) are siblings, nodes representing the data centers 630A-630B in an availability zone (itself represented by the node 620A) are siblings). For example, if packets sent to a server by all other servers in the rack have been dropped or if all inter-data center communications for a particular data center were dropped.

If the analyzer cluster 170 determines that a node is unreachable by its siblings, the analyzer cluster 170 puts the node into a failure state (operation 950). In some example embodiments, operations 920-950 are iterated over for all nodes prior to proceeding with operation 960. In other example embodiments, operations 920-950 are iterated over for a subset of all nodes prior to proceeding with operation 960 (e.g., all nodes in a data center, all nodes in an availability zone, all nodes for which response data was updated within a prior time period (e.g., the last minute or the last 10 minutes), or any suitable combination thereof).

In operation 960, the analyzer cluster 170 determines if a node and all of its children are in a failure state. If yes, the analyzer cluster 170 generates an internal issue alert for the node (operation 970). The generated internal issue alert may use the alert data structure 1100, discussed with respect to FIG. 11, below. In various example embodiments, additional or fewer checks are performed and corresponding alert types are generated.

In operation 1010, the analyzer cluster 170 determines if the node is in a failure state but none of its children are in the failure state. For example, a data center node may enter the failure state in operation 950, indicating that other data centers are unable to contact the data center. Nonetheless, the servers within the data center may be able to contact each other and the trace collector cluster 150. Accordingly, the nodes corresponding to the servers within the data center would not be placed in the failure state by operation 950. When the test in operation 1010 is true, the analyzer cluster 170 generates a connectivity alert for the node (operation 1020).

In operation 1030, the analyzer cluster 170 determines if at least one, but not all, children of a node are in a failure state. When the test in operation 1030 is true, the analyzer cluster 170 generates a not responsive alert for the child nodes in the failure state, if the child nodes are server nodes (operation 1040). In some example embodiments, operations 960-1040 are iterated over for all nodes or for the same set of nodes for which operations 910-950 were iterated over.

Compared to manual fault detection by system administrators, the use of the method 900 of automated fault detection may be faster and less prone to error. As a result, uptime of network resources may be improved, reducing the impact of faults. Additionally, the use of resources (such as power, CPU cycles, and data storage) for detection and repair of faults may be reduced by virtue of the method 900 of automated fault detection.

FIG. 11 is a block diagram illustration of a data format suitable for use in automated fault detection, diagnosis, and localization in data center networks, according to some example embodiments. The alert data structure 1100 may be used by the analyzer cluster 170 in issuing alerts regarding network problems determined through analysis of data contained in the trace database 160, for example during the method 900. As shown in FIG. 11, the alert data structure 1100 includes an alert identifier 1105, a node identifier 1110, a node level 1115, an alert start time 1120, an alert end time 1125, a status 1130, an urgent flag 1135, a code 1140, a description 1145, a sample flows field 1150, and an all flows field 1155. In various example embodiments, more or fewer fields are used.

The alert identifier 1105 is a unique identifier for the alert. For example, alerts may be numbered sequentially, as they are created.

The node identifier 1110 is an identifier for the node that is the subject of the alert. For example, an alert that applies to a single server would contain the identifier of the node corresponding to that single server in the node identifier 1110. As another example, an alert that applies to an entire data center would contain the identifier of the node corresponding to that data center in the node identifier 1110.

The node level 1115 identifies the level of the node identified by the node identifier 1110. That is, the node level 1115 identifies whether the alert applies to a single server, a rack, a data center, or an availability zone.

The alert start time 1120 and alert end time 1125 indicate the start and end times of the alert. When the alert is first created, the alert end time 1125 may be null. For example, when a server loses connectivity to the network, an alert may be created with an alert start time 1120 that indicates the time at which connectivity was lost. When connectivity to the server is restored, the alert data structure 1100 may be updated to indicate the time of restoration in the alert end time 1125.

The status 1130 indicates the current status of the alert. For example, while a node is experiencing an error condition, the status may be “active,” indicating that the alert refers to a current condition. Once the error condition has been addressed, the status may change to “inactive,” indicating that the alert data structure 1100 refers to a past condition.

The urgent flag 1135 is set to true if the alert is urgent and false otherwise. In some example embodiments, the urgent flag 1135 is set to true based on the level of the node (e.g., an entire data center being inaccessible may be urgent while a single server being down may not be urgent), the duration of the alert (e.g., an alert may not be urgent when created, but may become urgent based on the passage of time (e.g., one minute, one hour, or one day) without a resolution), the type of the alert (e.g., a connectivity alert may be urgent while a high drop rate alert is not), or any suitable combination thereof.

The code 1140 indicates the type of the alert and may be a numeric or alphanumeric code. For example, the code 1 may indicate a connectivity alert, the code 2 may correspond to a high drop rate alert, and so on.

The description 1145 is a human-readable description of the alert. The description 1145 may be based on any combination of the other fields of the alert data structure 1100. For example, the description 1145 may be a text string that corresponds to the code 1140 (e.g., “connectivity alert” or “high drop rate alert”). As another example, the description 1145 may be a text string that indicates all of the fields in the alert data structure 1100 (e.g., “Connectivity Alert (ID 1) for Data Center 3 began at Jan. 1, 2017 12:01:00 AM and continued until Jan. 1, 2017 12:05:43 AM. Alert is inactive and not urgent.”).

The all flows 1155 includes data for all flows experiencing packet drops related to the alert. The data included in the all flows 1155 for each flow may be the source IP address and destination IP address or the 5-tuple of (source IP address, destination IP address, source port, destination port, transport protocol).

The sample flows 1150 includes data for a subset of all flows experiencing packet drops related to the alert. The data included in the sample flows 1150 may be of the same format as for the all flows 1155. In some example embodiments, a set number of flows are included in the sample flows 1150 (e.g., three flows).

FIG. 12 is a flowchart illustration of a method 1200 of probe list creation, according to some example embodiments. The method 1200 includes operations 1210, 1220, 1230, 1240, 1250, and 1260. By way of example and not limitation, the pseudo-code below may be used to implement the method 1200. The method 1200 may be performed by the controller 180 of FIGS. 1-4 to prepare the lists of servers to be sent in operation 820 of the method 800.

```
identifyProbeLists( ) {
  for (each server s in network) {
  // Operation 1210 - start with a blank list
  s.probeList.clear( );
  // Operation 1220 - add each other server in the rack to the list
  for (each server x in s.rack)
    if (x != s) s.probeList.add(x);
  }
  // Operation 1230 - for each rack pair in each datacenter
  for (each datacenter dc in network) {
  for (each rack sourceRack in dc) {
    for (each rack destinationRack in dc) {
    // Operation 1230 - select a server in each rack of the pair to probe
    // another server in the other rack of the pair
    if (sourceRack != destinationRack) {
      // pick a random server in the source and destination racks
      s = getRandom(sourceRack.servers);
      x = getRandom(destinationRack.servers);
      s.probeList.add(x);
    }
    }
  }
  }
  // Operation 1240 - for each data center pair in each availability zone
  for (each availabilityzone az in network) {
  for (each datacenter sourceDC in az) {
    for (each datacenter destinationDC in az) {
    // Operation 1240 - select a server in each data center of the pair
    to probe
    // another server in the other data center of the pair
    if (sourceDC != destinationDC ) {
    11 // pick a random server in the source and destination data centers
      s = getRandom(sourceDC.servers);
      x = getRandom(destinationDC.servers);
      s.probeList.add(x);
    }
    }
  }
  }
  // Operation 1250 - for each availability zone pair, select a server in each
  // availability zone of the pair to probe another server in the other
  availability
  // zone
  for (each availabilityzone sourceAZ in network) {
  for (each availabilityzone destinationAZ in network) {
    if (sourceAZ != destinationAZ ) {
    // pick a random server in the source and destination
    availability zones
    s = getRandom(sourceAZ.servers);
    x = getRandom(destinationAZ.servers);
    s.probeList.add(x);
    }
  }
  }
}
```

In some example embodiments, servers in a failure state (as reported by the analyzer cluster 170) are not assigned a probe list in the identification step. This may avoid having some routes assigned only to failing servers, which may not actually send the intended probe packets. In some example embodiments, servers in the failure state are assigned to additional probe lists. This may allow for the gathering of additional information regarding the failure. For example, if a server was not accessible from another data center in its availability zone in the previous iteration, that server may be probed from all data centers in its availability zone in the current iteration, which may help determine if the problem is with the server or with the connection between two data centers.

FIG. 13 is a block diagram illustrating circuitry for implementing algorithms and performing methods, according to example embodiments. All components need not be used in various embodiments. For example, the clients, servers, and cloud-based network resources may each use a different set of components, or in the case of servers for example, larger storage devices.

One example computing device in the form of a computer 1300 (also referred to as computing device 1300 and computer system 1300) may include a processing unit 1305, memory storage 1310, removable storage 1330, and non-removable storage 1335. Although the example computing device is illustrated and described as the computer 1300, the computing device may be in different forms in different embodiments. For example, the computing device may instead be a smartphone, a tablet, a smartwatch, or another computing device including elements the same as or similar to those illustrated and described with regard to FIG. 13. Devices, such as smartphones, tablets, and smartwatches, are generally collectively referred to as “mobile devices” or “user equipment”. Further, although the various data storage elements are illustrated as part of the computer 1300, the storage may also or alternatively include cloud-based storage accessible via a network, such as the Internet, or server-based storage.

The memory storage 1310 may include volatile memory 1320 and persistent memory 1325, and may store a program 1315. The computer 1300 may include—or have access to a computing environment that includes—a variety of computer-readable media, such as the volatile memory 1320, the persistent memory 1325, the removable storage 1330, and the non-removable storage 1335. Computer storage includes random-access memory (RAM), read-only memory (ROM), erasable programmable read-only memory (EPROM) and electrically erasable programmable read-only memory (EEPROM), flash memory or other memory technologies, compact disc read-only memory (CD ROM), digital versatile disks (DVD) or other optical disk storage, magnetic cassettes, magnetic tape, magnetic disk storage or other magnetic storage devices, or any other medium capable of storing computer-readable instructions.

The computer 1300 may include or have access to a computing environment that includes input 1345, output 1340, and a communication connection 1350. The output 1340 may include a display device, such as a touchscreen, that also may serve as an input device. The input 1345 may include one or more of a touchscreen, a touchpad, a mouse, a keyboard, a camera, one or more device-specific buttons, one or more sensors integrated within or coupled via wired or wireless data connections to the computer 1300, and other input devices. The computer 1300 may operate in a networked environment using the communication connection 1350 to connect to one or more remote computers, such as database servers. The remote computer may include a personal computer (PC), server, router, network PC, peer device or other common network node, or the like. The communication connection 1350 may include a local area network (LAN), a wide area network (WAN), a cellular network, a WiFi network, a Bluetooth network, or other networks.

Computer-readable instructions stored on a computer-readable medium (e.g., the program 1315 stored in the memory 1310) are executable by the processing unit 1305 of the computer 1300. A hard drive, CD-ROM, and RAM are some examples of articles including a non-transitory computer-readable medium such as a storage device. The terms “computer-readable medium” and “storage device” do not include carrier waves to the extent that carrier waves are deemed too transitory. “Computer-readable non-transitory media” includes all types of computer-readable media, including magnetic storage media, optical storage media, flash media, and solid-state storage media. It should be understood that software can be installed in and sold with a computer. Alternatively, the software can be obtained and loaded into the computer, including obtaining the software through a physical medium or distribution system, including, for example, from a server owned by the software creator or from a server not owned but used by the software creator. The software can be stored on a server for distribution over the Internet, for example.

Devices and methods disclosed herein may reduce time, processor cycles, and power consumed in allocating resources to clients. Devices and methods disclosed herein may also result in improved allocation of resources to clients, resulting in improved throughput and quality of service.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

What is claimed is:

1. A device comprising:
a memory storage comprising instructions;
a network interface connected to a network; and
one or more processors in communication with the memory storage, wherein the one or more processors execute the instructions to perform:
identifying a set of servers in a plurality of data centers, the set of servers including a first server and a second server;
sending, via the network interface, a first list of servers in the set of servers to the first server;
sending, via the network interface, a second list of servers in the set of servers to the second server;
receiving, via the network interface, a first set of response data from the first server, the first set of response data indicating responsiveness of the servers in the first list of servers;
receiving, via the network interface, a second set of response data from the second server, the second set of response data indicating responsiveness of the servers in the second list of servers;
analyzing the first set of response data and the second set of response data; and
based on the analysis, generating an alert that indicates a network error in a data center of the plurality of data centers.

2. The device of claim 1, wherein the analyzing of the first set of response data and the second set of response data comprises:
determining a drop rate for a third server in the first list of servers.

3. The device of claim 1, wherein the analyzing of the first set of response data and the second set of response data comprises:
determining a failure state for a third server in the first list of servers.

4. The device of claim 1, wherein the analyzing of the first set of response data and the second set of response data comprises:
using a tree data structure in which each leaf node of the tree corresponds to a server of the set of servers; and
determining that all servers in the set of servers corresponding to sibling nodes of a node corresponding to a third server in the set of servers report dropped packets to the third server.

5. The device of claim 1, wherein the analyzing of the first set of response data and the second set of response data comprises:
using a tree data structure in which each leaf node of the tree corresponds to a server of the set of servers and each other node of the tree corresponds to a distinct subset of the set of servers; and
determining that a node in the tree data structure and all children of the node are in a failure state.

6. The device of claim 1, wherein the analyzing of the first set of response data and the second set of response data comprises:
using a tree data structure in which each leaf node of the tree corresponds to a server of the set of servers and each other node of the tree corresponds to a distinct subset of the set of servers; and
determining that a node in the tree is in a failure state and that no children of the node are in the failure state.

7. The device of claim 1, wherein the analyzing of the first set of response data and the second set of response data comprises:
using a tree data structure in which each leaf node of the tree corresponds to a server of the set of servers and each other node of the tree corresponds to a distinct subset of the set of servers; and
determining that a node is not in a failure state and that at least one child of the node is in the failure state.

8. The device of claim 1, wherein the one or more processors further perform:
creating the first list of servers by including each server in a same rack as the first server.

9. The device of claim 1, wherein the one or more processors further perform:
creating the first list of servers by including a third server, based on the third server being in a different rack than the first server.

10. The device of claim 1, wherein the one or more processors further perform:
creating the first list of servers by including a third server, based on the third server being in a different data center than the first server.

11. A computer-implemented method for automated fault detection in data center networks comprising:
identifying, by one or more processors, a set of servers in a plurality of data centers, the set of servers including a first server and a second server;
sending, via a network interface, a first list of servers in the set of servers to the first server;
sending, via the network interface, a second list of servers in the set of servers to the second server;
receiving, via the network interface, a first set of response data from the first server, the first set of response data indicating responsiveness of the servers in the first list of servers;
receiving, via the network interface, a second set of response data from the second server, the second set of response data indicating responsiveness of the servers in the second list of servers;
analyzing, by the one or more processors, the first set of response data and the second set of response data; and
based on the analysis, generating an alert that indicates a network error in a data center of the plurality of data centers.

12. The computer-implemented method of claim 11, wherein the analyzing of the first set of response data and the second set of response data comprises:
determining a drop rate for a third server in the first list of servers.

13. The computer-implemented method of claim 11, wherein the analyzing of the first set of response data and the second set of response data comprises:
determining a failure state for a third server in the first list of servers.

14. The computer-implemented method of claim 11, wherein the analyzing of the first set of response data and the second set of response data comprises:
using a tree data structure in which each leaf node of the tree corresponds to a server of the set of servers; and
determining that all servers in the set of servers corresponding to sibling nodes of a node corresponding to a third server in the set of servers report dropped packets to the third server.

15. The computer-implemented method of claim 11, wherein the analyzing of the first set of response data and the second set of response data comprises:
using a tree data structure in which each leaf node of the tree corresponds to a server of the set of servers and each other node of the tree corresponds to a distinct subset of the set of servers; and
determining that a node in the tree data structure and all children of the node are in a failure state.

16. The computer-implemented method of claim 11, wherein the analyzing of the first set of response data and the second set of response data comprises:
using a tree data structure in which each leaf node of the tree corresponds to a server of the set of servers and each other node of the tree corresponds to a distinct subset of the set of servers; and
determining that a node in the tree is in a failure state and that no children of the node are in the failure state.

17. The computer-implemented method of claim 11, wherein the analyzing of the first set of response data and the second set of response data comprises:
using a tree data structure in which each leaf node of the tree corresponds to a server of the set of servers and each other node of the tree corresponds to a distinct subset of the set of servers; and
determining that a node is not in a failure state and that at least one child of the node is in the failure state.

18. A non-transitory computer-readable medium storing computer instructions for automated fault detection in data center networks, that when executed by one or more processors, cause the one or more processors to perform steps of:
identifying a set of servers in a plurality of data centers, the set of servers including a first server and a second server;
sending, via a network interface, a first list of servers in the set of servers to the first server;
sending, via the network interface, a second list of servers in the set of servers to the second server;
receiving, via the network interface, a first set of response data from the first server, the first set of response data indicating responsiveness of the servers in the first list of servers;
receiving, via the network interface, a second set of response data from the second server, the second set of response data indicating responsiveness of the servers in the second list of servers;
analyzing the first set of response data and the second set of response data; and
based on the analysis, generating an alert that indicates a network error in a data center of the plurality of data centers.

19. The non-transitory computer-readable medium of claim 18, wherein the analyzing of the first set of response data and the second set of response data comprises:
determining a drop rate for a third server in the first list of servers.

20. The non-transitory computer-readable medium of claim 18, wherein the analyzing of the first set of response data and the second set of response data comprises:
determining a failure state for a third server in the first list of servers.
